(19) United States
(12) Patent Application Publication
(10) Pub. No.: US 2012/0175282 A1
(43) Pub. Date: Jul. 12, 2012

(54) POUCH HAVING OBTUSE-ANGLED CORNER

(75) Inventor: Gautam BHATTACHARJEE, Beijing (CN)

(73) Assignee: The Procter & Gamble Company, Cincinnati, OH (US)

(21) Appl. No.: 13/346,984

(22) Filed: Jan. 10, 2012

(30) Foreign Application Priority Data
Jan. 10, 2011 (CN) PCT/CN2010/000037

(51) Int. Cl. B65D 85/00; B32B 37/06; B65B 51/10

(52) U.S. Cl. 206/524.1; 53/373.7; 53/477; 156/543

(57) ABSTRACT

A pouch has a sheet containing at least one layer of a film material. The sheet forms a tube that is sealed to form a volume. The seal contains a first straight edge and a second straight edge adjoining the first straight edge. The first straight edge forms an obtuse angle with the second straight edge. A sealing jaw and a method for forming such a pouch is also described.

### FIELD OF THE INVENTION

The present invention relates to pouches. Specifically, the present invention relates to sealed pouches formed from a film material.

### BACKGROUND OF THE INVENTION

Pouches are typically formed of a laminate or a film and may be used for holding many types of items such as food, shampoos, detergents, medicines, etc. In order to prevent them from leaking, they are often sealed on all sides to form a fixed volume to contain a product, for example a granular detergent. However it is always a challenge to balance pouch waste and strength against bursting and leakage. The strength of a seal is directly proportional to the sealing area itself. If the pouch is sealed with too much sealing area on the sides, then the given volume per area of film is smaller, leading to wasted film. However, if the sealing area is too narrow, then the pouch will easily burst if dropped.

Typically a pouch is sealed with a straight seal forming approximately a 90° angle. While this is an efficient means of sealing the top, it has now been found that this leads to easy puncture of the pouch's corner in response to a sudden impact, such as when the pouch is dropped, when something else is dropped onto the pouch, etc. Such a sudden impact could occur at any time prior to opening for use, such as during the filling/manufacturing process, shipping, storage, transportation, etc. Such an undesirable puncture leads to waste, messiness, product loss, etc. and in some cases, a customer may even refuse to purchase a product in a punctured pouch.

Existing methods to solve this problem employ stronger sealing techniques and adhesives, stronger films and pouch materials, and/or different laminate layers within a film material. However, all of these methods typically increase complexity, and require special capability beyond that available at the machine where the forming, filling and sealing takes place.

Accordingly, the need exists for an improved pouch which is more resistant to puncture at the corners, especially while employing existing film materials, sealing processes, and sealing machinery.

### SUMMARY OF THE INVENTION

The present invention relates to a pouch having a sheet containing at least one layer of a film material. The sheet forms a tube that is sealed to form a volume. The seal contains a first straight edge and a second straight edge adjoining the first straight edge. The first straight edge forms an obtuse angle with the second straight edge.

A sealing jaw contains a sealing arm and a receiving arm. The sealing arm contains a sealing area further containing a first straight edge-forming element and a second straight edge-forming element adjoining the first straight edge-forming element. The first straight edge-forming element forms an obtuse angle with the second straight edge-forming element. A method for sealing a pouch includes the steps of providing a sheet, forming a tube having a leading edge, sealing the leading edge to form a leading edge seal, filling the tube with a predetermined amount of a product, sealing the tube to form a trailing edge seal, and cutting the tube after the trailing edge seal to form a pouch. The leading edge seal and the trailing edge seal form a volume therebetween and the volume contains the product. At least one of the leading edge seal or trailing edge seal contains a first straight edge and a second straight edge adjoining the first straight edge. The first straight edge forms an obtuse angle with the second straight edge.

It has now been found that the invention can significantly reduce puncturing at the corners by blunting the force when, for example, the filled pouch is dropped.

### BRIEF DESCRIPTION OF THE DRAWINGS

While the specification concludes with claims particularly pointing out and distinctly claiming the invention, it is believed that the invention will be better understood from the following description of the accompanying figures in which like reference numerals identify like elements, and wherein:

FIG. 1 is a front view of an embodiment of the pouch herein;

FIG. 2 is a cut-away view of the pouch of FIG. 1, as seen along line 2-2;

FIG. 3 is a front view of an existing comparative pouch;

FIG. 4 is a front view of an existing comparative pouch;

FIG. 5 is a front view of an existing comparative pouch;

FIG. 6 is a front view of an embodiment of the sealing arm according to the invention herein;

FIG. 7 is a front view of an embodiment of the receiving arm according to the invention herein; and

FIG. 8 is a front view of an embodiment of the pouch herein.

The figures herein are not necessarily drawn to scale.

### DETAILED DESCRIPTION OF THE INVENTION

All temperatures herein are in degrees Celsius (° C.) unless otherwise indicated. As used herein, the term “comprising” means that other steps, ingredients, elements, etc. which do not adversely affect the end result can be added. This term encompasses the terms “consisting of” and “consisting essentially of”.

As used herein, the term “fabric enhancer” includes a composition intended to provide an improved scent, softness, anti-static benefit, and/or shape-retention benefits to a fabric, such as a fabric conditioner, and/or a fabric softener. Such a fabric enhancer is typically intended to function in the rise cycle of a laundering process.

This disclosure relates to a pouch having a sheet containing at least one layer of a film material. The sheet forms a tube that is sealed to form a volume. The seal contains a first straight edge and a second straight edge adjoining the first straight edge. The first straight edge forms an obtuse angle with the second straight edge. This disclosure also relates to methods and equipment for making such a pouch.

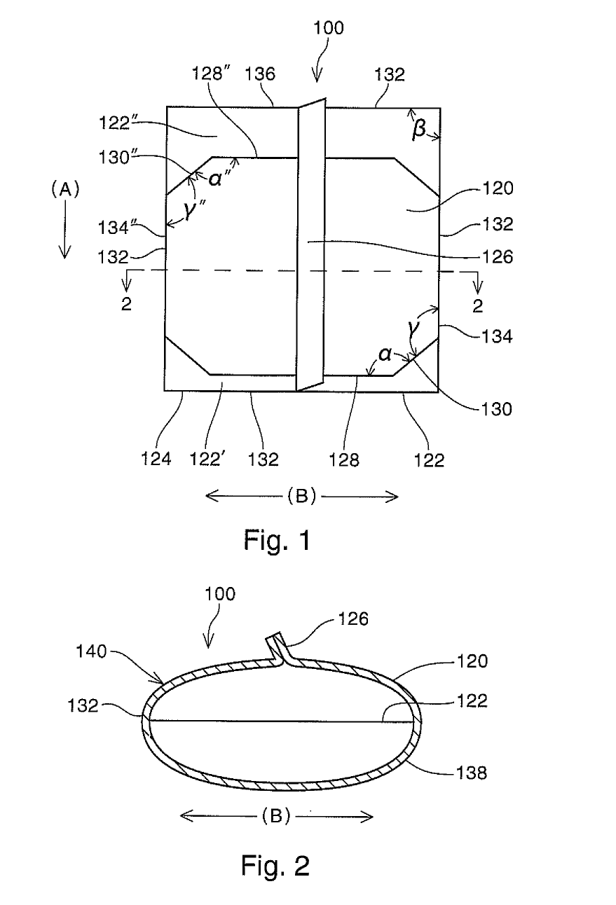

Referring to the Figures herein, FIG. 1 is a front view of an embodiment of the pouch, 100, containing a sheet, 120, formed into a tube (see FIG. 2 at 138). The pouch is formed of a sheet which is in turn formed from at least one film material typically selected from the group consisting of polyamide (nylon), polyethylene, polypropylene, ethyl-vinyl-acetate, poly-4-methylpentene-1, a microporous membrane, and a combination thereof; or polyamide (nylon), linear low-density polyethylene, an oriented polypropylene, polyethylene terephthalate, and a combination thereof. Generally, softer and more stretchy film materials also may reduce rupturing, and therefore extrusion lamination, co-extrusion lamination, and blends of film materials, such as polyethylene and polyethylene terephthalate are useful herein.

The film material may also be affixed to and/or contain a metal therein, and/or be a metalized film. Film materials are well known in the art and may further contain resins, laminates, printed artwork, additives (i.e., UV blockers, antimicrobials, dyes, pigments, etc.), etc. Suitable film materials are available from various suppliers worldwide such as 3M Company (St. Paul, Minn., USA), Du Pont Co. (Wilmington, Del., USA), Toppan Insatsu Co. (Tokyo, Japan), Gelman Sciences Company (Ann Arbor, Mich., USA), and many other suppliers worldwide. The sheet herein may contain either a single layer or contain multiple layers of the same, or different film material(s), so long as it remains sealable. The sheet is typically from about 15 μ to about 220 μ, or from about 20 μ to about 200 μ, or from about 25 μ to about 160 μ thick. Each individual film material may be oriented, or random as desired.

Multiple layers of film materials may be joined together to form a sheet with multiple properties and/or benefits. In such cases, it is known in the art to join the multiple layers together by, for example, lamination, heat sealing, ultrasonic sealing, gluing, pressure sealing, etc.

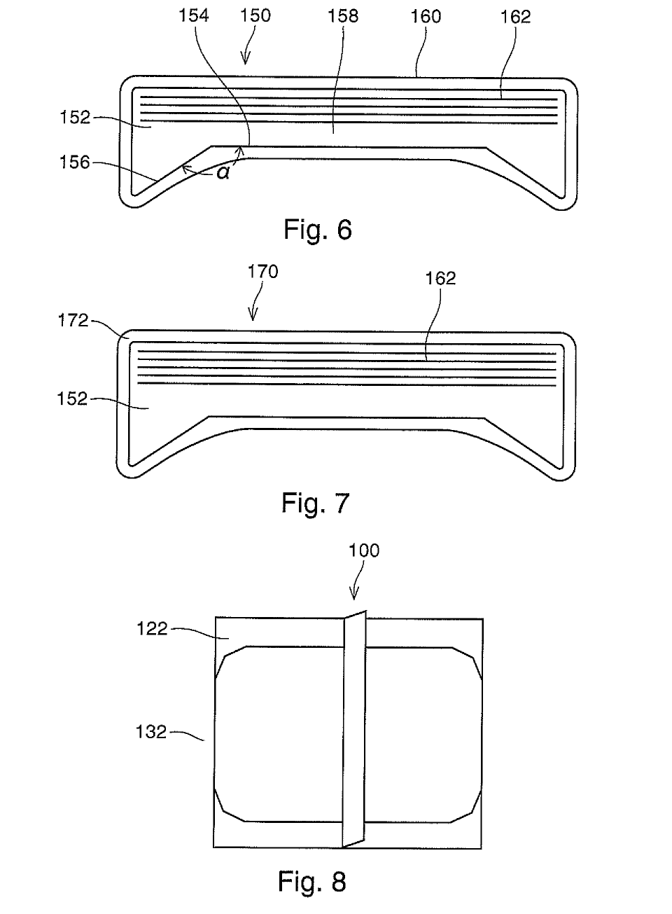

The sheet, 120, may then be formed into a pouch, 100, by pulling and/or stretching the sheet, 120, around a forming tube (not shown) to form a tube (see FIG. 2 at 138) out of the sheet, 120. The tube (see FIG. 2 at 138) is formed by sealing the edges of the sheet, 120, in any direction such as the machine direction at any point or continuously, and/or by sealing the edges in the cross direction at either the leading edge and/or the trailing edge. The forming tube doubles as a filling tube, through which the product to be contained in the pouch is then filled into the tube (see FIG. 2 at 138). The sheet is pulled or advanced in the machine direction (A), and the sealing jaw (see FIG. 6 at 150) simultaneously seals and cuts the trailing portion of the tube (see FIG. 2 at 138) in the cross direction (B). This simultaneously releases the filled pouch and forms a new seal, 122, at the leading edge, 124. Machinery and techniques for forming such filled pouches are often referred to as “autopacking machines” and are well known in the art and are available from multiple suppliers around the world. Autopacking machines are also often described in the industry as in-line packing and sealing machines, and/or form-fill-seal (FFS) machines.

Thus, in FIG. 1, the sheet, 120, is sealed in the machine direction (A) to form a fin seal, 126, resulting in the continuous production of a tube (see FIG. 2 at 138). The leading edge, 124 is then sealed by a sealing jaw (see FIG. 6 at 150), typically in the cross direction (B), to form the volume (see FIG. 2 at 140) closed at the seal, 122.

In FIG. 1, the seal, 122, is a leading edge seal, 122′, and contains a first straight edge, 128, and a second straight edge, 130, The first straight edge, 128, and the second straight edge, 130, form an angle, α, therebetween. In the current case, the angle, α, is an obtuse angle.

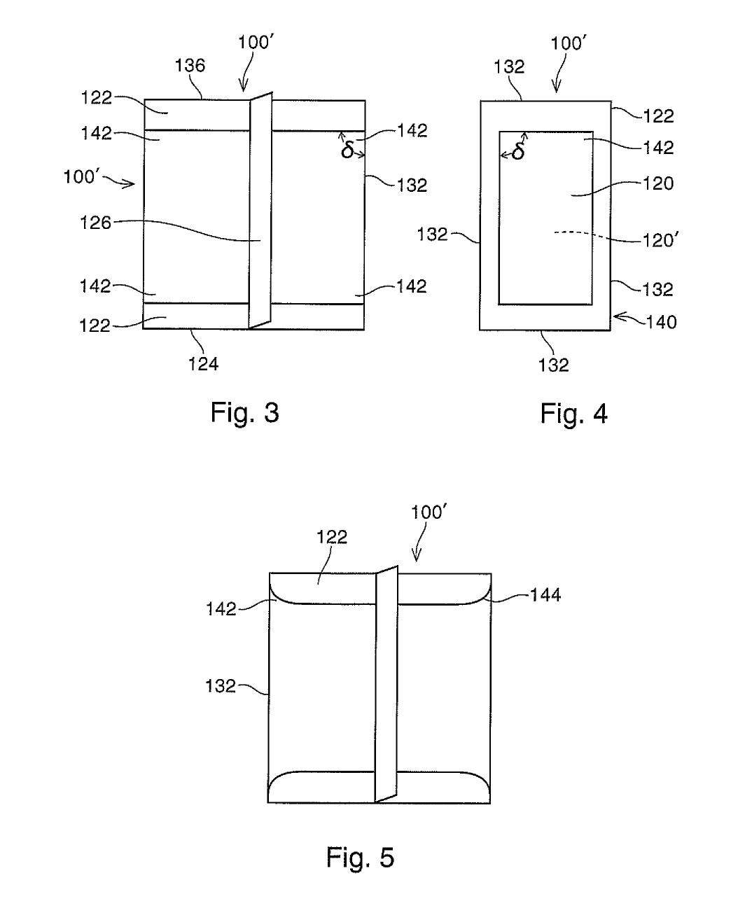

Without intending to be limited by theory, it is believed that typical pouches contain a right angle, or even an acute angle at the corners where the leading edge seal and/or the trailing edge seal meets the edge of the standard pouch (see, FIGS. 3-5). It is now believed that many punctures of standard pouches (see FIGS. 3-5), such as those containing granular laundry detergents, is caused by a small amount of granular product that accumulates in the corner of the pouch, and may contain a little air or other granular products behind it—which forms a dart like sharp corner and when the pouch receives an impact, from, for example, dropping, falling, another pouch hitting it, etc. the small amount of granular product is forced at a relatively high velocity towards the corner. As the angle formed by the sides and seal are either acute or a right angle, the force of the plurality of moving granules is concentrated to a single point in the corner. These multiple, high-velocity impacts may weaken the film material and/ or even cause the body or surface taking the impact to burst. Thus, even though the individual granules are themselves quite light, the cumulative impacts to the material in the corner potentially result in a tearing of the film from within, and cause the film material at the pouch body to fail, resulting in a pouch that leaks from the body.

In contrast, the pouch herein contains a corner where the angle, α, is an obtuse angle, or from about 100° to about 170°, or from about 115° to about 165°, or from about 125° to about 155°. Without intending to be limited by theory, it is believed that the obtuse angle blunts the force of the plurality of moving granules and the above ranges of obtuse angles provide a good balance between effective puncture resistance and effective use of the space within the pouch. It is also believed that the obtuse angle distributes this force over a greater area, instead of concentrating it like a right or acute angle may do. As a result, the film material maintains its integrity and is less prone to bursting or failure. A typical pouch has approximately a rectangular or square 2-dimentional face, and therefore the edges, 132, will still typically form right angles, β. Such pouches (see also FIGS. 3-5) are the most common and the easiest to make. As the angle, α, between the first straight edge, 128, and the second straight edge, 130, is an obtuse angle, this means that for a typical pouch, 100, herein as shown in FIG. 1 a third straight edge, 134, may be, for example, the edge, 132, of the pouch, 100. The third straight edge, 134 and the second straight edge, 130, may also form an angle, γ, which may also be obtuse or from about 100° to about 170°, or from about 115° to about 165°, or from about 125° to about 155°, the actual angle, γ, being dependent on and complementary to the actual angle, α. In another embodiment, additional straight edges and corresponding angles are contemplated, and may be particularly useful herein. In an embodiment herein as seen in FIG. 1, each leading edge seal contains a first set of a first straight edge, a second straight edge, and an obtuse angle therebetween and a second set of a first straight edge, a second straight edge, and an obtuse angle therebetween; the first set at the opposite end of the leading edge seal from the second set. In an embodiment herein as seen in FIG. 1, each trailing edge seal contains a first set of a first straight edge, a second straight edge, and an obtuse angle therebetween and a second set of a first straight edge, a second straight edge, and an obtuse angle therebetween; the first set at the opposite end of the trailing edge seal from the second set.

In FIG. 1, the trailing edge, 136, also contains a seal, 122″, a first straight edge, 128″, and a second straight edge, 130″.The first straight edge, 128″, and the second straight edge, 130″, also form an angle, α″, therebetween. Similarly, the edge, 132, of the pouch is a third straight edge, 134″, that forms an obtuse angle, γ″, with the second straight edge, 130″. One skilled in the art will understand that in some VFFS machines, the order of the trailing edge and the leading edge may be reversed, as compared to FIG. 1.

FIG. 2 is a cut-away view of the pouch, 100, in FIG. 1, as seen along line 2-2. One can clearly see that the sheet, 120, has been formed into a tube, 138, by joining the sheet, 120 to itself at the fin seal, 126. This tube, 138, is also sealed at the far end by the seal, 122, that then defines a volume, 140. The volume, 140, can contain a material such as a granular product (not shown), therein to protect it from spillage, moisture, the outside atmosphere, etc. Thus, in FIG. 2, the pouch is formed in what is commonly known in the art as a “pillow pouch” or a “pillow bag”. While the pouch may be formed into other pouches such as gusset bags, wicket bags, standup bags, etc., it is believed that the puncture problem described herein is particularly prominent in pillow bags. Accordingly, in an embodiment of the invention, the pouch is a pillow bag.

The product (not shown) to be filled into the pouch typically has a bulk density of at least 250 g/L, or from about 300 g/L to about 1.3 kg/L, or from about 450 g/L to about 1.1 kg/L. The product is typically a granular product; or a fine granular product, such as a granular product having a number-median particle size of from about 10 μ to about 5 mm. In an embodiment herein, the fine granular product is a granular detergent, a granular fertilizer, a granular fabric enhancer, a granular mineral, and/or a granular medicine; or a granular laundry detergent, and/or a granular fabric enhancer.

The volume, 140, may be either airtight or may allow air to flow into and or out of the volume, 140. In an embodiment herein the volume is airtight (or substantially airtight) once all the seals are in formed and place; only upon puncture thereof is air and/or the granular product easily let into or let out of the volume. Such an airtight pouch is typical of current bags containing, for example, a granular laundry detergent, as described in the examples. In another embodiment herein, the pouch may allow air to pass out of the volume, by, for example having a valve, a seal design allowing air to pass therethrough (see, e.g., US Patent Publication No. 2009/226573 A1 to Gonzales, et. al., published on Sep. 10, 2009), and/or having small holes purposely formed into the pouch. However, in such cases, air typically can escape from the volume only relatively slowly, and therefore the puncturing problem at the corners due to a sudden impact still exists. Without intending to be limited by theory, it is believed that in pouches where air is allowed to quickly exit the pouch, then the bursting and/or puncturing problem does not significantly exist.

The volume typically ranges from (when sealed) at least 500 mL, or from about 500 mL to about 100 L, or from about 800 mL to about 60 L, or from about 1 L to about 30 L, or from about 1.5 L to about 20 L. Typically the pouch will contain both the product as well as air (or another type of gas) therein, because without air in the package (i.e., a vacuum-packed package), the product does not move, and therefore problem does not exist. Thus, in an embodiment herein, the pouch comprises air therein, and the product in the pouch is not vacuum-packed.

FIG. 3 shows a front view of an existing pouch, 100′, where no obtuse angle is present at each volume corner, 142. The pouch, 100′, is a typical pillow bag having a fin seal, 126, and seals, 122, at the leading edge, 124, and the trailing edge, 136. The edge, 132, and the seal, 122, form a typical angle, 6, of substantially 90°. Typically, this angle is repeated at each of the 4 volume corners, 142.

Similarly, FIG. 4 shows a front view of an existing comparative pouch, 100′, having a substantially continuous seal, 122, all around the perimeter thereof. Such a pouch, 100′, is typically formed of two separate sheets, 120, 120′, of film material, sealed at all the edges, 132. to form a volume, 140, therein. Such a pouch, 100′, also typically has an angle, δ, of substantially 90° where seal, 122, forms a volume corner, 142. Typically, this angle is repeated at each of the 4 volume corners, 142.

FIG. 5 shows a front view of an existing comparative pouch, 100′, with a curve, 144, in the seals, 122, at each of the volume corners, 142. This embodiment was allegedly created to solve a similar puncture problem as described herein; however, it was not successful.

FIG. 6 shows a front view of an embodiment of a sealing arm, 150, of the present invention. The sealing arm, 150, and the receiving arm (see FIG. 7, at 170), are opposed to each other, either permanently or temporarily, to form a sealing jaw (not shown). The sealing arm, 150, contains a sealing area, 152, for forming the seal (see FIG. 1 at 122). The sealing area, 152, further contains a first straight edge-forming element, 154, connected to a second straight edge-forming element, 156. The first straight edge-forming element, 154, and the second straight edge-forming element, 156, form an obtuse angle, α, therebetween.

In the embodiment of FIG. 6, the sealing arm, 150, contains a heating element, 158, that keeps the sealing arm, 150, in the sealing area, 152, hot enough to melt the sheet (see FIG. 1 at 120). One skilled in the art will understand that many methods and apparatuses to seal the sheet(s) together to make the seal (see FIG. 1 at 122), are applicable, such as, heat sealing, ultrasonic sealing, pressure sealing, adhesive sealing, etc. In an embodiment herein, the seal is formed by heat sealing and/or ultrasonic sealing; or heat sealing.

In FIG. 6, the sealing area, 152 terminates in a cut blade, 160, that cuts the pouch (see FIG. 1 at 100) at the same time the sealing area, 152, seals the sheet(s) (see FIG. 1 at 120) together. Where one does not want to actually separate individual pouches, but instead wants to make them continuous, such as, for example, in a streamer, the cut blade, 160, may be replaced with a line of needles or a line of intermittent cut blades, to make, for example, a perforation. Other methods and elements for making a line of weakness are also known in the art. Furthermore, as one skilled in the art would realize, the cut blade(s) should be of sufficient structural integrity, and durability to both penetrate all layers of the pouch completely, and also be oriented to easily release the finished pouch after the seal and perforation is made. In an embodiment herein, the cut blade is from about 1 cm to about 10 μ, or from about 5 mm to about 20 μ, or from about 2 mm to about 40 μ in height, as measured perpendicularly from the surface of the sealing arm, 150. The cutting blade may be straight, jagged, curved, etc. as desired. In an embodiment herein the cut blade may be perpendicular to the surface of the sealing arm, or may be angled in the machine direction. Without intending to be limited by theory, it is believed that if the cut blade is perpendicular to the surface of the sealing arm, then at slower machine speeds the cut blade will more effectively form the cuts. However, it is believed that at faster autopacking machine speeds, a cut blade that is angled in the direction of the package flow may more quickly release the finished pouch, so as to reducing jamming of the autopacking machine caused by a failure of the finished pouch to drop away from the sealing arm.

In an embodiment herein, a plurality of sealing jaws may be used such that, for example, a sealing jaw may be present to seal the top of the pouch and cut it away, while a separate but adjacent sealing jaw may simultaneously seal the bottom of the next pouch.

The sealing arm, 150, also contains optional sealing ridges, 162, which may provide textured seals. Such textured seals may be desirable in some instances to produce, for example, an easier to grip seal, to enhance seal strength, aesthetic reasons, etc.

In an embodiment herein, the sealing jaw is designed so that it can cut a handle in the seal by, for example including a handle cutting element. Such a handle cutting element may also be formed by, for example, one or more cut blades

FIG. 7 is a front view of an embodiment of a receiving arm, 170, of the present invention. The receiving arm, 170, complements the sealing arm (FIG. 6 at 150), and is a minor image thereof, containing a complementary sealing area, 152, which matches with the sealing arm's sealing area, 152 (see FIG. 6). The receiving arm, 170, contains a cut channel, 172, which is typically a concave indentation or depression in the surface of the receiving arm, 170, that allows the cut blade(s) (FIG. 6 at 160), etc. to punch through the sheets and form the respective cut, perforation, etc. The receiving arm, 170, also contains sealing ridges, 162, to complement those on the sealing arm (FIG. 6 at 150).

In an embodiment herein, the cut blade(s) is releasably attached to the sealing arm, so that when it wears out it may be removed, sharpened and/or replaced without having to fabricate an entire new sealing arm.

The sealing arm, 150, the receiving arm, 170, or both actively interact to form the seal by, for example, heat sealing, ultrasonic sealing, pressure sealing, etc. as desired, and therefore contains the appropriate sealing technology therein or thereupon, such as, for example, a heater, an ultrasonic generator, a pressure clamp, etc. The sealing arm and the receiving arm are typically each independently formed of an appropriate durable material for their uses herein, such as, for example, a metal, a ceramic, a plastic, and a combination thereof. A sealing jaw intended for heat sealing should be both strong and conduct heat well and may be formed of, for example, copper, brass, steel, or iron, aluminum, etc. Impulse and induction sealing methods are known in the art and are useful herein. Based on this disclosure, a sealing arm and a receiving arm according to the present invention may be custom made by various suppliers and/or machine shops around the world.

One skilled in the art will recognize that the sealing jaw herein may be used on an autopacking machine.

FIG. 8 shows a front view of an embodiment of the pouch, 100, herein containing three obtuse angles formed between the seal, 122, and the edge, 132. One skilled in the art will understand that other variations containing different numbers of obtuse angles is also encompassed herein. In an embodiment herein, the pouch contains (in total) more than about 2 obtuse angles, or from about 2 to about 16, or from about 4 to about 10, or from about 6 to about 8 obtuse angles.

In an embodiment herein the invention is combined with additional techniques known in the art, such as a laser-cut, a half-cut, a score line, embossing, etc. and the known methods and machinery therefor. In an embodiment herein, a reclosing technology is combined with the invention herein, to allow easy and efficient reclosing of the pouch after opening. Such reclosing technologies are also especially beneficial with larger-sized pouches. Typical reclosing technologies are known in the art and include plastic pressure-sensitive zippers, hook and loop fastening systems, zipper systems, adhesive strips and patches, clips and snaps, locking systems, etc. For additional technologies useful in combination with the present invention, see, EP Patent No. 1 409 366 B1 to Camargo-Parodi, et al., granted on Jun. 21, 2006; and EP Patent Application No. 07119454.2 To Rogers, filed on Oct. 29, 2007.

### Example 1

Pouches according to FIG. 1 and FIG. 2, are formed on a FFS machine from a sheet using the sealing jaw of FIGS. 6-7. The FFS machine creates all seals by heating to create thermal bonding between the separate sheets. The sheet is a three layer laminate of the film materials polyethylene terepthalate, a metallic film (like MYLAR®), and polyethylene. The sheet is provided on a roll which feeds into the FFS machine and is stretched onto an area where the tube is formed by sealing a fin seal in the machine direction. The tube has a leading edge which is sealed to form a leading edge seal using the sealing jaws according to FIGS. 6-7. A predetermined weight (2 kg) of a granular laundry detergent is filled into and flows down the tube and the tube is sealed using the sealing jaws of FIGS. 6-7 to form a filled pillow pouch containing 2 kg of granular laundry detergent. The process then repeats itself for the next pouch.

Comparative pouches according to FIG. 3 are formed from the same materials as used above on a standard FFS machine, employing a standard set of sealing jaws. These comparative pouches have substantially 90° angles at all of the volume corners.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A pouch comprising:
a. a sheet comprising at least one layer of a film material, the sheet forming a tube; and
b. a seal forming the tube into a volume,
wherein the seal comprises a first straight edge, wherein the seal comprises a second straight edge adjoining the first straight edge, and wherein the first straight edge forms an obtuse angle with the second straight edge.

2. The pouch according to claim 1, wherein the pouch is formed by an autopacking machine.

3. The pouch according to claim 1, comprising a granular product therein.

4. The pouch according to claim 1, wherein the film material is from about 15 μ to about 220 μ thick.

5. The pouch according to claim 1, wherein the pouch further comprises a third straight edge adjoining the second straight edge, and wherein the second straight edge forms an obtuse angle with the third straight edge.

6. The pouch according to claim 1, wherein the volume is substantially airtight.

7. The pouch according to claim 1, wherein the seal is a leading edge seal, and wherein the pouch further comprises a trailing edge seal opposed to the leading edge seal.

8. The pouch according to claim 3, wherein the granular product is a granular laundry detergent.

9. A sealing jaw comprising:
a. a sealing arm comprising a sealing area, the sealing area comprising:
i. a first straight edge-forming element; and
ii. a second straight edge-forming element adjoining the first straight edge-forming element,
wherein the first straight edge-forming element forms an obtuse angle with the second straight edge-forming element; and
b. a receiving arm,
wherein the sealing arm and the receiving arm are complementary and wherein the sealing arm and the receiving arm may interact to seal a sheet therebetween.

10. The sealing jaw of claim 9 wherein the sealing arm comprises a heating element.

11. The sealing jaw of claim 9 wherein the receiving arm comprises a heating element.

12. An autopacking machine comprising the sealing jaw according to claim 9.

13. A method for sealing a pouch comprising the steps of:
a. providing a sheet;
b. forming a tube having a leading edge;
c. sealing the leading edge to form a leading edge seal;
d. filling the tube with a predetermined amount of a product;
e. sealing the tube to form a trailing edge seal, wherein the leading edge seal and the trailing edge seal form a volume therebetween, and wherein the volume comprises the product therein; and
f. cutting the tube after the trailing edge seal to form a pouch,
wherein at least one of the leading edge seal or the trailing edge seal comprises a first straight edge and a second straight edge adjoining the first straight edge and wherein the first straight edge forms an obtuse angle with the second straight edge.
